(19) United States
(12) Patent Application Publication
(10) Pub. No.: US 2026/0334727 A1
(43) Pub. Date: Oct. 29, 2026

(54) METHOD AND DEVICE FOR CLEANING A LIQUID

(71) Applicant: Vito AG, Tuttlingen (DE)

(72) Inventor: Andreas Schmidt, Tuttlingen (DE)

(21) Appl. No.: 19/107,849

(22) PCT Filed: Aug. 29, 2023
(86) PCT No.: PCT/EP2023/073591

§ 371 Date: Feb. 28, 2025

(30) Foreign Application Priority Data
Aug. 30, 2022 (DE) 10 2022 121 856.2

(51) Int. Cl. A47J 37/12

(52) U.S. Cl. CPC A47J 37/1223; A47J 37/1285

(57) ABSTRACT

The subject matter provides a method and a device for cleaning oil in a tank of a deep fat fryer, by a filter element through which the oil flows. The oil is removed from the deep fat fryer. preferably during operation of same, directed through the filter element and brought back into the tank.

### CROSS-REFERENCE TO RELATED APPLICATIONS

This application claims the benefit of and priority to International Application No. PCT/EP 2023/073591, filed 29 Aug. 2023, which claims priority to German Application No. DE 102022121856.2, filed 30 Aug. 2022, the disclosures of which are incorporated by reference herein in their entireties.

### BACKGROUND

The invention relates to a method for cleaning a liquid, in particular oil, that is used in a tank of a deep fat fryer, by means of a filter element through which the liquid flows, and a device for this purpose.

There are a large number of liquids in the private and industrial sectors that need to be cleaned. These include, for example, cooling or lubricant tanks for machine tools or edible oils, e.g., from deep fat fryers. These are just a few examples, but the invention is intended to apply to all possible liquids to be cleaned.

WO 02/28505 discloses such a device for cleaning liquids, in particular edible oils, by means of a filter in a filter housing, wherein the filter is connected downstream of a pump, and a motor is provided in a housing for driving the pump, which has a rotor with a rotor disc with blades in an immersion housing. The housing, immersion housing and filter housing together form a unit that can be at least partially inserted into and removed from the liquid to be cleaned. This device has been proven worldwide.

A further development of this device is described in DE 10 2020 134 844 A1.

### SUMMARY

The object of the subject matter is to develop a method and a device of the above-mentioned type that can be used in a variety of ways and, above all, can also be used in machines already on the market.

To achieve the object, the liquid is preferably removed from the deep fat fryer during operation, passed through the filter element and returned to the tank.

The method according to the invention thus ensures continuous cleaning of the liquid even when a deep fat fryer, for example, is in operation. Of course, discontinuous operation is also possible and should be covered by the concept of the invention. The only important thing is that the liquid to be cleaned is removed from the liquid tank, cleaned and returned to the tank.

The simple design of the entire liquid circuit is impressive in this exemplary embodiment. It must be emphasised that the liquid to be cleaned is guided under the filter element and pressed through the filter element from below. This means that the impurities filtered out of the liquid do not clog the filter element too quickly from above, but that heavier impurities in particular sediment downwards, allowing the filter to remain open and carry out its cleaning function.

The liquid to be cleaned is thus removed from the tank, pressed through the filter element from below and returned to the tank. The recirculation should preferably take place via a duct with which the flow can reach as many areas of the tank as possible, so that no pockets are formed in which impurities can accumulate. To ensure this, it may even be necessary to move the duct, which can be done by means of fluid mechanics or a motor, for example.

Preferably, both the removal of the liquid and the return take place in a single pipe section, which can be easily inserted into the drain of existing systems for retrofitting. The other elements of the liquid circuit are then connected to this pipe section. It is precisely the possibility of retrofitting devices already on the market and in use that is an emphasised feature of the present invention.

When it comes to the device for cleaning a liquid, in particular oil, in a tank of a deep fat fryer, by means of a filter element, a liquid circuit for the liquid from the tank and back into the tank is to be assigned to the tank, wherein the filter element is connected into the liquid circuit. This filter element is preferably located in a removable filter box so that it can be easily replaced. The filter box can also be easily cleaned in this way.

Preferably, the filter element divides the filter box into a lower and an upper chamber, both of which may be separated from the filter element by any separating element, in particular, for example, by a perforated plate.

The lower chamber is to be connected to a pump, which is also connected to the liquid circuit. The pipe section described above, which is connected to the tank drain, flows into this pump. The pump then presses the liquid into the lower chamber of the filter box, i.e. under the filter.

A return line for the liquid leads from the upper chamber of the filter box back into the tank, wherein this return line preferably runs through the pipe section. The return line emerges from the pipe section into the tank with a nozzle, wherein the duct mentioned above is provided in the nozzle.

### BRIEF DESCRIPTION OF THE DRAWINGS

Further advantages, features and details of the subject matter are shown in the following description of preferred exemplary embodiments and with reference to the drawings, in which:

FIG. 1 shows a front view the device according to the invention for cleaning a liquid;

FIG. 2 shows a perspective view of the device according to FIG. 1;

FIG. 3 shows a further perspective view of the device according to FIG. 2 from the side from below;

FIG. 4 shows a side view of a large part of the device according to FIG. 1;

FIG. 5 shows a side view of a schematically illustrated, partially open filter box;

FIG. 6 shows a schematic and block diagram of the method for cleaning a liquid according to the invention.

### DETAILED DESCRIPTION

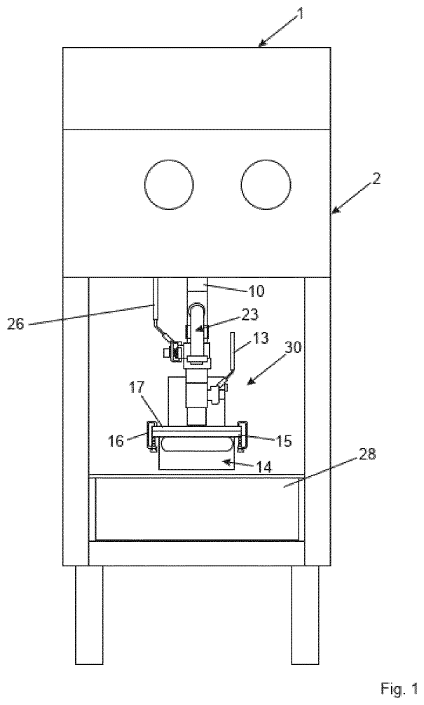

According to the subject matter, a device for cleaning a liquid has an insert 1 with a tank 3, which is inserted into a housing 2, as shown in FIG. 1. This housing 2 is preferably open at the front, but can of course also be closed.

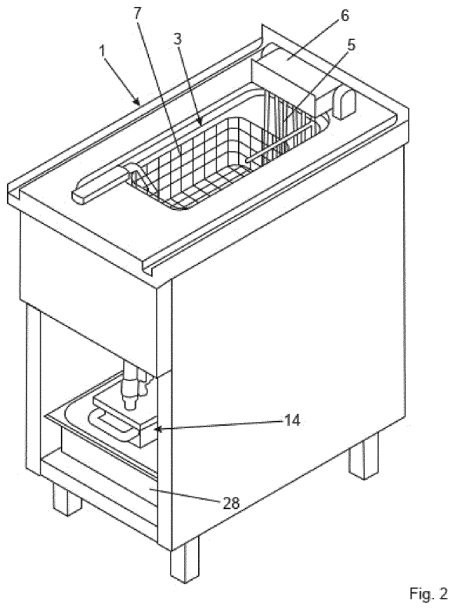

According to FIG. 2, the tank 3 contains a liquid 4 shown in FIG. 5. Heating rods 5 are immersed in the tank 3 to heat the liquid 4.

A folding device 6 for folding the heating rods 5 out of the tank 3 is assigned to these heating rods 5. There is also a basket 7 in the tank 3 for holding a product to be fried, for example. In this case, the liquid 4 is a suitable frying oil.

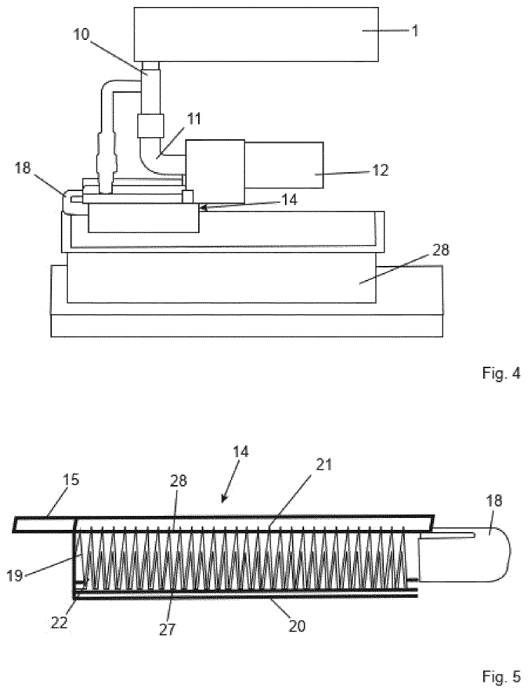

A drain 9 is provided in a possibly lower-lying region 8 of the tank 3, into which a liquid circuit 30 according to the invention is inserted. This drain 9 leads into a pipe section 10, which in turn is connected to a pump 12 via an elbow 11. A ball valve is inserted into the elbow 11, which can be operated by means of a lever 13. This ball valve 13 is omitted in FIG. 4.

A filter box 14 is connected downstream of the pump 12. This filter box 14 has an upper frame 15, which is connected to a machine-fixed frame 17 via clamping elements 16. A corresponding seal is arranged therebetween. After releasing the clamping elements 16, the filter box 14 can be removed from the frame 15 and the contents of the filter box 14 can be cleaned or replaced.

FIG. 5 shows the filter box 14 with its handle 15 more clearly, wherein a zigzag filter element 19 divides a lower chamber 20 from an upper chamber 21 of the filter box. The zigzag filter element 19 overlaps a corresponding grid 22 and is fixed on this grid 22.

From the upper chamber 21, a pipe arrangement 23 leads back into the pipe section 10 and continues in the pipe section 10 with a nozzle 24, which opens out of the drain 9 and has a duct 25 there. A further ball valve with a lever 26 is also connected to the pipe arrangement 23.

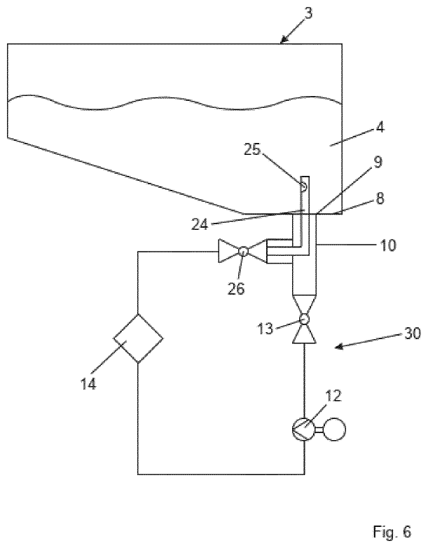

The functioning of the following invention is as follows and is explained in more detail with reference to FIG. 6 in particular.

Due to the design of the tank 3 with the lower-lying region 8, it is possible to use the liquid circuit 30 according to the invention during operation of the device itself, i.e. with the heating rods 5 folded in and the basket 7 inserted during frying. However, the concept of the invention naturally also includes the fact that the liquid circuit 30 is operated outside the activity of the device. In particular and clearly emphasised is the possibility of subsequently inserting the liquid circuit 30 into existing devices or tanks 3 by simply designing the pipe section 10 with an annular collar at its free end, wherein a corresponding seal is inserted between the annular collar and the bottom of the tank 3 when this pipe section 10 is inserted.

To operate the device, the ball valve is opened with the lever 13 so that liquid can be removed from the tank 3 by the pump 12. The pump 12 presses this liquid into the lower chamber 20 of the filter box 14 under the filter element 19 and presses it through the filter element 19 from below. For example, a perforated plate 27 can be provided below the grid 22 to delimit the filter element. A further perforated plate 28 or the like can also be provided towards the upper chamber 21, which delimits this upper chamber 21 from the filter element 19.

After the cleaned liquid enters the upper chamber 21, it passes into the pipe arrangement 23 and from there through the open ball valve with the lever 26 into the nozzle 24 in the pipe section 10 and is discharged from the nozzle 24 through the duct 25 into the tank 3. This duct 25 can, for example, be equipped separately or aligned so that there are no dead zones in the tank 3 in which impurities in the liquid can accumulate. For example, it may also be possible for the duct 25 to be moved by a suitable device or as a result of the flow of the liquid itself, so that it covers different zones of the tank 3 in varying ways.

After a predetermined time or at regular intervals, the filter box 14 is removed, cleaned and/or the corresponding filter is replaced after closing the ball valves by releasing the clamping elements 16.

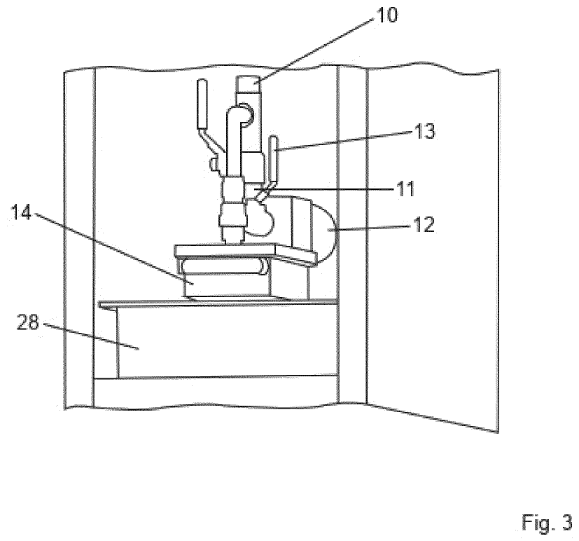

FIGS. 1 to 4 also show that an additional trough 28 is inserted under the liquid circuit 30, which trough collects any oil that may escape from the liquid circuit 30. However, appropriate seals should prevent this.

1. Method for cleaning oil in a tank of a deep fat fryer, by a filter element through which the oil flows, wherein
the oil is removed from the deep fat fryer, directed through the filter element, and brought back into the tank.

2. Method according to claim 1, wherein the oil is guided under the filter element and pressed through the filter element from underneath.

3. Method according to claim 1, wherein the oil is pressed out from a duct back into the tank.

4. Method according to claim 3, wherein the duct is moved.

5. Method according to claim 1, wherein the oil is removed out from a pipe section, into which the oil is returned after cleaning.

6. Device for cleaning oil, in a tank of a deep fat fryer, by a filter element wherein a liquid circuit for the oil from the tank and back into the tank is integrated to the tank, wherein the filter element is connected into the liquid circuit.

7. Device according to claim 6, wherein the filter element is located in a filter box configured to be removed from the liquid circuit.

8. Device according to claim 7, wherein the filter element divides the filter box into a lower chamber and an upper chamber.

9. Device according to claim 8, wherein the filter element is bounded upwards or downwards by a perforated plate.

10. Device according to claim 9, wherein the lower chamber is connected to a pump, which is connected to the liquid circuit.

11. Device according to claim 10, wherein the pump is connected to a drain of the tank via a pipe section.

12. Device according to claim 11, further comprises a return line for the oil leading from the upper chamber of the filter box into the pipe section.

13. Device according to claim 12, wherein the return line opens out of the pipe section into the tank with a nozzle, wherein a duct is connected with the nozzle.

14. Device according to claim 13, wherein the nozzle is configured to be moved.
